(19) United States
(12) Patent Application Publication
(10) Pub. No.: US 2009/0115114 A1
(43) Pub. Date: May 7, 2009

(54) LEAF SPRING SUPPORT AND A PARABOLIC LEAF SPRING ARRANGEMENT

(76) Inventor: Rolf Rodin, Hisings Karra (SE)

Correspondence Address: WRB-IP LLP, 1217 KING STREET, ALEXANDRIA, VA, 22314, US

(21) Appl. No.: 12/300,123

(22) PCT Filed: May 16, 2007
(86) PCT No.: PCT/SE07/00491

§ 371 Date: Nov. 9, 2008

(30) Foreign Application Priority Data
May 18, 2006 (SE) 0601116-7

(51) Int. Cl. F16F 1/20; B60G 11/02

(52) U.S. Cl. 267/43; 267/52

(57) ABSTRACT

A leaf spring support is provided for the mutual lateral support of, and insertion between, two leaves in a leaf spring assembly comprises a base portion, from which lateral wings extend upwards and downwards in relation to the plane of the base portion. The distance between the wings is such that the leaves fit between the wing portions. The downwardly extending wings are placed on either side of the upwardly extending wings.

### BACKGROUND AND SUMMARY

The present invention relates to a leaf spring support for the mutual lateral support of two leaves in a leaf spring assembly according to the preamble of claim 1, and to a parabolic leaf spring arrangement according to claim 7.

In the art of vehicle suspension, leaf spring assemblies are widely used, primarily for heavy duty vehicles like trucks, buses, rail vehicles, etc. Although other types of suspensions, e.g. torsion springs, helical springs and air suspensions are gaining popularity as compared to leaf spring assemblies, such assemblies are still very beneficial, primarily in terms of robustness and cost. These advantages do not only emanate from the uncomplicated design of the leaf spring assembly, but also from the fact that the leaf spring assembly can absorb longitudinal and lateral forces from the wheels of the vehicle, unlike the other mentioned suspension systems; hence, complicated wheel suspensions comprising rods, etc, can be avoided.

There are however some drawbacks with leaf spring assemblies, including large weight, high internal friction, and a stiffness varying with lateral forces.

In order to better understand the origin of these drawbacks, a brief explanation of the design of leaf spring assemblies will follow:

In FIGS. 3 and 4, two schematic views of prior art leaf spring assemblies are shown, wherein FIG. 3 is a side view of a leaf spring assembly loaded with a vertical force F, and FIG. 4 is a top view of the prior art leaf spring assembly loaded with a lateral force L.

The prior art leaf spring assembly shown in FIGS. 3 and 4 comprises two leaves, a top leaf L1 and a bottom leaf L2. The ends of the top leaf L1 are connected to a vehicle (not shown) at a front spring anchorage FS and a rear spring anchorage RS; the bottom leaf L2 may be connected to the vehicle at the front suspension FS, whereas the other end of the bottom leaf L2 is free to move. The rear spring anchorage RS may comprise a sliding attachment or a spring shackle to allow for longitudinal movements of the spring end in relation to the vehicle. There is a large clearance in the connection of the bottom leaf L2 at the front spring anchorage FS. The only rigid connection between the two leaves L1 and L2 is by a centrally placed bolt assembly B. As is inherent in any spring arrangement, the spring leaf assembly will react upon a load variation (of the force F) by deflecting. Upon deflecting, the bottom leaf L2 will be more deflected than the top leaf L1; this means that the deflection radius of the leaf L2 will be smaller than the deflection radius of the leaf L1, which in turn means that there will be a sliding between the two leaves L1 and L2. This sliding in turn leads to an inner friction, i.e. a hysteresis effect, of the leaf spring assembly. FIG. 4 shows the effect of a lateral load L on the prior art leaf spring assembly. As can be seen, the top leaf L1 will experience a lateral deflection, whereas the bottom leaf L2 will remain straight. Since the two leaves only are connected to one another in the vicinity of the front spring anchorage FS and by the bolt assembly B, the bottom leaf L2 will end up off line with the top leaf L1, especially in the vicinity of the rear spring anchorage RS, where the leaves according to the prior art spring are not connected. This leads to the spring assembly gaining a lower stiffness during a lateral bend.

In U.S. Pat. No. 2,028,299 (FIG. 8), a leaf spring spacer partly addressing the problem with lateral deflection of the leaves is shown. There is however a severe problem with the design according to this patent, namely that the leaf spring spacer will experience a twisting effect as it transfers a lateral force from the top leaf to the bottom leaf, due to the fact that the leaf spring support is—“unbalanced”, i.e. a force transferred through the leaf spring support cannot pass straight through the center of the leaf spring support. The twisting of the leaf spring support of the prior art could lead to the leaves being squeezed between the wings transferring the lateral force from one leaf to the neighboring leaf; hence, the internal friction could increase significantly.

The leaf support according to the invention solves this and other problems by providing a balanced leaf spring support comprising downwardly extending wings placed on either sides of upwardly extending wings.

In FIGS. 5 and 6 a parabolic leaf spring arrangement for a vehicle according to prior art is illustrated. The leaf spring arrangement can comprise two or more leaf elements, preferably two or three leaf elements. Usually the parabolic leaf spring arrangement comprises leaf elements having substantially equal length. Each leaf element has a varying thickness with a relatively thin thickness of material at the both ends of the leaf element and greater thickness of material at the middle portion thereof. This implies the parabolic leaf arrangement does not require a lot of leaf elements as a conventional multi leaf spring arrangement which has a great number of leaf elements of different length. In such a multi leaf spring arrangement each leaf element has a constant thickness of material, and all leaf elements have usually one and the same thickness of material.

The parabolic leaf spring arrangement according to prior art has a spring shackle in each end so as to prevent a lateral deflection of the leaf elements relative to each other. Such a spring shackle has a holder portion and a bolt, and is usually connected to the lowermost leaf element with a rivet to keep the spring shackle in the desired position with respect to the longitudinal extension direction of the leaf spring arrangement. At the upper side of the shackle the bolt/nut can be tightened so as to adjust the holder portion and prevent displacement of the leaf elements relative to each other when the leaf spring arrangement is subjected to a lateral load. However, the rivet is loaded and during unfavorable conditions it can be broken by such a lateral force.

Accordingly, it is desirable to provide a parabolic leaf spring arrangement in which arrangement mutual displacement of the leaf element to be connected to a vehicle, usually the uppermost leaf element, and the adjacent leaf element is prevented, and which arrangement at the same time reduces the problem associated with the rivet used in prior art parabolic leaf spring arrangements.

By the use of a leaf support according to an aspect of the invention instead of a shackle according to prior art, all lateral forces can be absorbed by the wings of the support leaf. This implies that any means used for keeping the leaf support in the desired position with respect to the longitudinal extension direction of the leaf spring arrangement can remain unloaded when the leaf spring arrangement is subjected to a lateral force. In addition, the leaf support according to the invention is cost effective compared to the prior art shackle.

### BRIEF DESCRIPTION OF THE DRAWINGS

Hereinafter, the invention will be explained with reference to the appended drawings, wherein:

FIG. 1 is a perspective view showing a leaf spring support according to the present invention,

FIG. 2 is a side view showing the leaf spring support in FIG. 1 mounted between two leaves of a leaf spring assembly,

FIG. 3 is a schematic side view of a prior art leaf spring assembly,

FIG. 4 is a schematic top view of a prior art leaf spring assembly under influence of a lateral force,

FIG. 5 is a schematic side view of a parabolic leaf spring arrangement according to prior art,

FIG. 6 is an enlarged perspective cut view of one end of the parabolic leaf spring arrangement in FIG. 5 showing a spring shackle connected to the leaf element by a rivet,

FIG. 7 is a schematic side view a parabolic leaf spring arrangement according to the invention, and

FIG. 8 is an enlarged view of the end of the parabolic leaf spring arrangement in FIG. 7.

### DETAILED DESCRIPTION

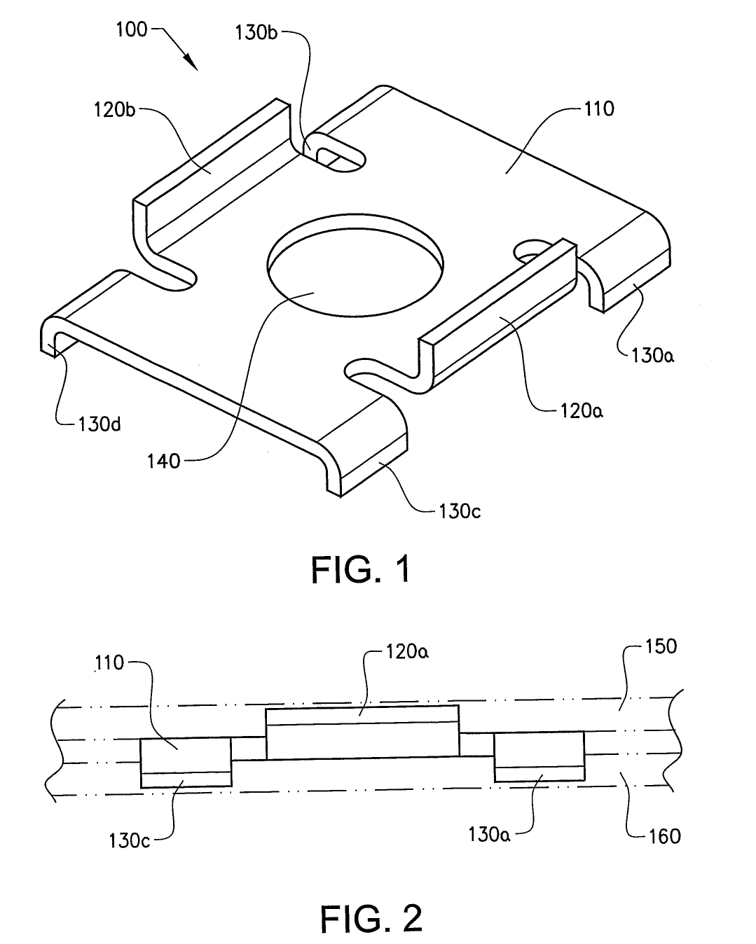

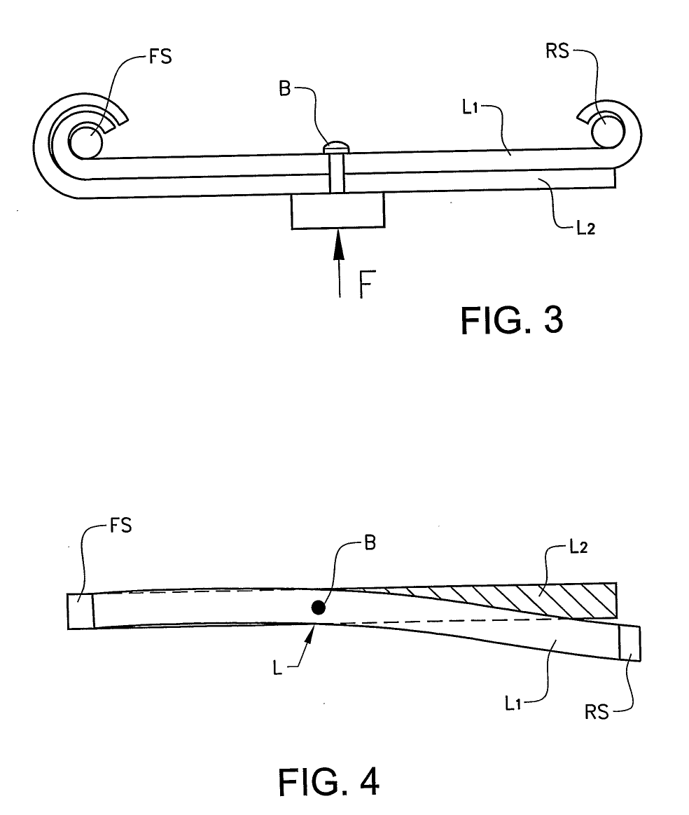

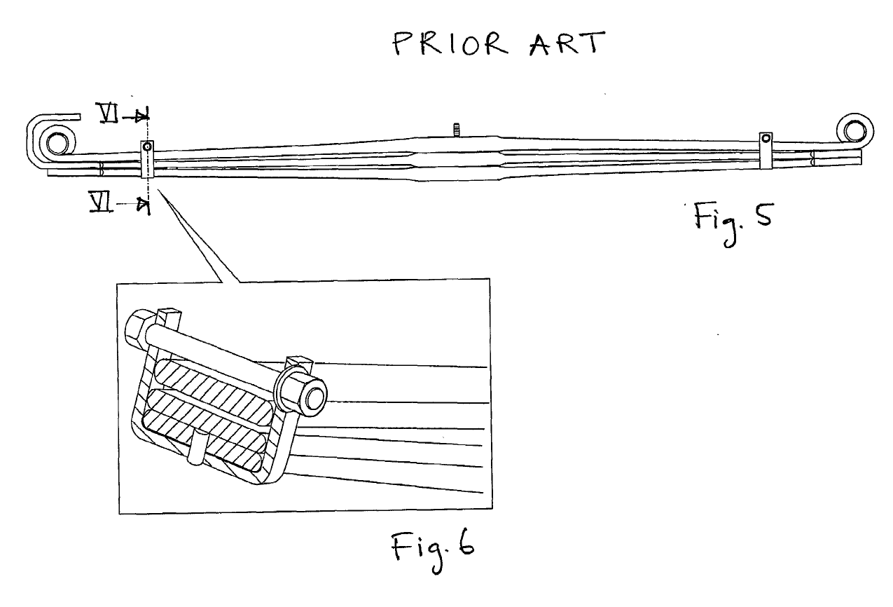

In FIG. 1, a leaf spring support 100 according to the present invention is shown. The leaf spring support 100 comprises a planar base portion 110, two upwardly extending lateral wings 120a, 120b, four downwardly extending lateral wings 130a, b, c and d, and a central opening 140. The distance between the downwardly extending wings 130a and 130c, and 130b and 130d, respectively, basically corresponds to the width of the upwardly extending wings 120a, 120b. Preferably, the leaf spring support 100 is made from a piece of sheet metal, which is punched and pressed to the described shape. As could be understood, it is also possible to manufacture a component of similar shape by other methods, e.g. die-casting or moulding. In FIG. 2, the leaf spring support 100 is shown positioned between two leaves 150 and 160. As can be seen, the upwardly extending lateral wing 120a will support the upper leaf 150, and the downwardly extending lateral wings 130a and 130c will support the bottom leaf 160. The thickness of the base portion 110 will keep the two leaves 150 and 160 at a predetermined minimal distance from one another. A projection (not shown) on either of the leaves could extend into the central opening 140 and stop the leaf spring support 100 from moving in the longitudinal direction of the leaves. As is obvious for a person skilled in the art, the distance between the lateral wings 120a and 120b is equal to, or slightly larger than, the width of either the leaf 150 or the leaf 160. The same is true for the distance between the wings 130a and 130b, and 130c and 130, respectively.

In use, the leaf spring support 100 is inserted between the two leaves 150 and 160, in the vicinity of a free end of the bottom leaf 160, wherein the lateral wings 120a, 130a and 130c will support one side of the leaves 150 and 160, and the lateral wings 120b, 130b and 130d will support the other side of the leaves; the base portion 110 will be squeezed between the leaves. As is obvious for a person skilled in the art, it is of no importance whether the lateral wings 120a and 120b are pointing upwards or downwards—the used terms “upwardly extending” and “downwardly extending” as used herein only refer to the directions shown in FIG. 1.

The widths of the wings are in one preferred embodiment such that the width of wing 120a is substantially equal with the width of the wings 130a and 130c added together. Other dimensional relations between the wings are possible, but preferably the width of wing 120a is greater than wing 130a or 130c. The widths of the wings 130a and 130c are substantially equal. As implied in the prior art section, internal friction of leaf springs could pose a severe problem, especially in terms of reduced driving comfort of the vehicle. The origin of the internal friction (a.k.a. hysteresis) is the sliding motion between the leaves of the leaf spring assembly when the spring works, i.e. the leaves are bent. With the leaf spring support 100 according to the invention, the internal friction could be reduced significantly, due to the fact that the leaves of the leaf spring assembly will be spaced from one another due to the thickness of the base portion 110. This means that the internal friction of a leaf spring assembly provided with the leaf spring support 100 will be concentrated to the base portion 110. Providing the base portion 110 with a coating of rubber or any friction reducing coating, e.g. a flour-carbon resin (such as sold under the trade mark Teflon), could reduce the friction even more.

The largest benefit of the leaf spring support 100 according to the present invention is, however, the ability to reduce lateral movement between the leaves 150 and 160. As mentioned in the prior art section, one benefit of leaf spring assemblies is that they can transfer lateral forces from a suspended wheel to the chassis of the vehicle. However, in prior art leaf spring assemblies, only the uppermost leaf will transfer lateral forces to the vehicle chassis, since there is nothing stopping lateral movement between the leaves (see FIG. 4). This does not only mean that the uppermost leaf will be exposed for major forces, but also means that the stiffness of the prior art leaf spring assembly will vary with varying amounts of lateral loads, since the free end of the prior art bottom leaf L2 will not rest against the prior art top leaf L1.

The leaf spring support 100 prevents lateral movement between the leaves by the provision of the two upwardly extending lateral wings 120a, 120b and the four downwardly extending lateral wings 130a, 130b, 130c and 130d. As can be seen, the wing 120a and the wings 130b and 130d “balance” one another, i.e. the base portion 110 will not experience any twisting motion around an imaginary axle extending through the central opening 140, perpendicular to the surface of the base portion 110, when the leaf spring support 100 transfers a lateral force between the two neighboring leaves 150, 160. In other words, a lateral force being transferred from either of the upwardly extending lateral wings 120a, 120b will be transferred, through the center of the base portion 110, to the downwardly extending lateral wings 130b, 130d and 130a, 130c, respectively.

The transfer of lateral forces between the leaves of the leaf spring assembly reduces lateral bending of the uppermost leaf, and also allows the leaf spring assembly to keep its stiffness even under lateral load, since the leaf spring support prevents the bottom leaf 160 to end up “off line” the upper leaf 150, such as shown in the prior art leaf spring assembly shown in FIG. 4. These two factors significantly increase vehicle stability and riding comfort.

As can be understood, the primary function of the leaf spring support is that the lateral forces between two neighboring leaves are “balanced” by the provision of two opposing wings extending in the opposite direction of a centrally placed wing extending in the other direction. The same effect could be obtained by providing, at each side of the leaf spring support 100, any uneven number of wings extending in opposite directions.

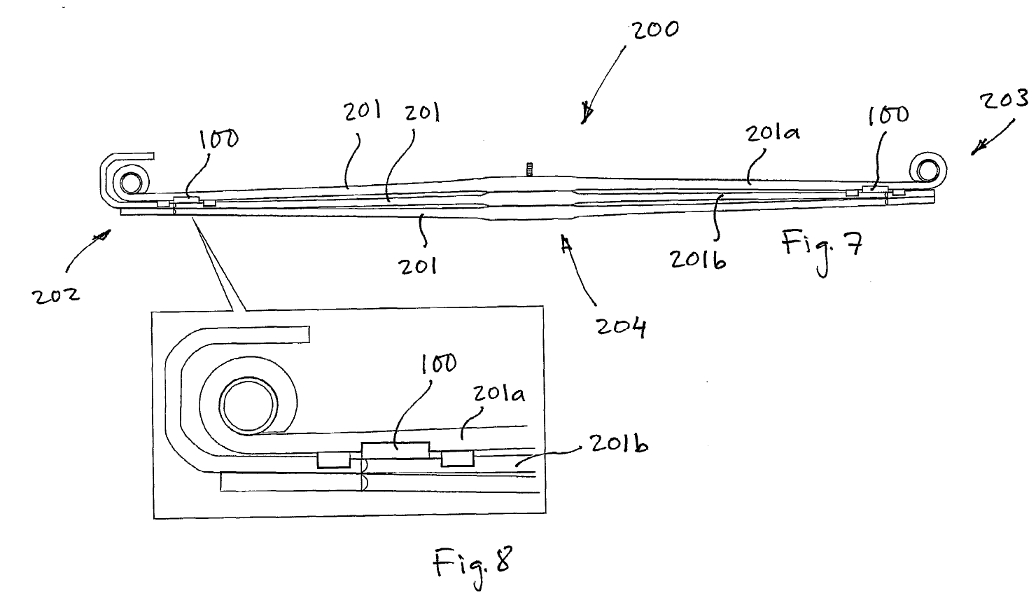

In FIGS. 7 and 8 a parabolic leaf spring arrangement 200 for a vehicle according to the invention is illustrated. The parabolic leaf spring arrangement can preferably be used in a wheel suspension for a truck. The parabolic leaf spring arrangement 200 can comprise two or more spring elements 201, preferably two or three leaf elements. Usually the parabolic leaf spring arrangement comprises leaf elements having substantially equal length. Each leaf element has a varying thickness with a relatively thin thickness of material at the both ends 202, 203 of the leaf element and greater thickness of material at the middle portion 204 thereof. The parabolic leaf spring arrangement 200 comprises at least one leaf support 100 inserted between said leaf elements as previously described herein with reference to FIGS. 1 and 2 which leaf support can absorb lateral forces. The leaf spring support 100 is arranged between two leaf elements in the leaf spring arrangement, preferably between the uppermost leaf element 201a connected to a vehicle (not shown) and the adjacent lower leaf element 201b. One such leaf support 100 is preferably arranged in each end of the leaf spring arrangement 200.

As also previously described herein the leaf support can be provided with a means, such as an aperture for receiving a projection from a leaf element, to prevent the leaf spring support from being displaced in the longitudinal direction. By the provision of the leaf support having said wings such a means for keeping the leaf support in the desired position with respect to the longitudinal extension direction of the leaf spring arrangement can remain substantially unloaded also when the leaf spring arrangement is subjected to a lateral force. The leaf support can be designed in such a way that the lateral force is solely absorbed by the wings of the leaf support.

It is to be understood that the present invention is not limited to the embodiments described above and illustrated in the drawings; rather, the skilled person will recognize that many changes and modifications may be made within the scope of the appended claims.

1. Leaf spring support for mutual lateral support of, and insertion between, two leaves in a leaf spring assembly, the support comprising a base portion from which upwardly directed lateral wings extend upwards and downwardly directed lateral wings extend downwards in relation to the plane of the base portion, wherein the distance between the wings which are arranged on two opposite sides of the base portion is such that the leaves fit between the wings, wherein on each of the two opposite sides of the base portion the downwardly extending wings are placed on either side of the upwardly extending wing.

2. The leaf spring support according to claim 1, wherein the bottom portion is provided with an opening for engagement with a projection on either of the leaves.

3. The leaf spring support according to claim 1, wherein the base portion is provided with a friction reducing coating.

4. The leaf spring support according to claim 1, wherein the spring support is made from sheet metal.

5. The leaf spring support according to claim 1, wherein the width of the upwardly directed wing is substantially equal with the width of the downwardly directed wings placed on either side thereof added together.

6. The leaf spring support according to claim 1, wherein the width of the upwardly directed wing is greater than the width of the downwardly wings placed on either side thereof added together.

7. A parabolic leaf spring arrangement comprising at least two leaf elements and at least one leaf spring support according to claim 1.

8. The leaf spring support according to claim 2, wherein the base portion is provided with a friction reducing coating.

9. The leaf spring support according to claim 2, wherein the spring support is made from sheet metal.

10. The leaf spring support according to claim 2, wherein the width of the upwardly directed wing is substantially equal with the width of the downwardly directed wings placed on either side thereof added together.

11. The leaf spring support according to claim 2, wherein the width of the upwardly directed wing is greater than the width of the downwardly wings placed on either side thereof added together.

12. The leaf spring support according to claim 3, wherein the spring support is made from sheet metal.

13. The leaf spring support according to claim 3, wherein the width of the upwardly directed wing is substantially equal with the width of the downwardly directed wings placed on either side thereof added together.

14. The leaf spring support according to claim 3, wherein the width of the upwardly directed wing is greater than the width of the downwardly wings placed on either side thereof added together.

15. The leaf spring support according to claim 4, wherein the width of the upwardly directed wing is substantially equal with the width of the downwardly directed wings placed on either side thereof added together.

16. The leaf spring support according to claim 4, wherein the width of the upwardly directed wing is greater than the width of the downwardly wings placed on either side thereof added together.
